(19) United States
(12) Patent Application Publication
(10) Pub. No.: US 2025/0095899 A1
(43) Pub. Date: Mar. 20, 2025

(54) CT ENERGY EXTRACTION DEVICE

(71) Applicant: Electric Power Research Institute of Yunnan Power Grid Co., Ltd., Kunming (CN)

(72) Inventors: Xiangyu TAN, Kunming (CN); Wenyun LI, Kunming (CN); Guochao QIAN, Kunming (CN); Lijun TANG, Kunming (CN); Gang AO, Kunming (CN); Xiaowei XU, Kunming (CN); Yong LU, Kunming (CN); Fangrong ZHOU, Kunming (CN); Zonghan JIAO, Kunming (CN); Ming YUAN, Kunming (CN); Wenbin ZHANG, Kunming (CN)

(21) Appl. No.: 18/573,366

(22) PCT Filed: Aug. 30, 2023
(86) PCT No.: PCT/CN2023/115854

§ 371 Date: Dec. 21, 2023

(30) Foreign Application Priority Data
Nov. 15, 2022 (CN) 202211422771.0

(51) Int. Cl. H01F 27/02; H01F 27/26; H01F 27/30; H01F 38/30

(52) U.S. Cl. CPC H01F 27/02; H01F 27/263; H01F 27/306; H01F 38/30; H01F 2038/305

(57) ABSTRACT

A CT energy extraction device is provided. A first accommodation cavity is provided in a first housing, and a second accommodation cavity is provided in a second housing. The first housing can be connected and joined with the second housing to form a ring shape, which is used to be placed on outside of a high-voltage line. A first iron core is disposed in the first accommodation cavity, and an energy-extraction coil is wound around the first iron core. A cable outlet is provided on the first housing, and the energy-extraction coil has pins extending from the cable outlet. A second iron core is disposed in the second accommodation cavity. When the first housing and the second housing are connected and joined, the first and second iron cores are joined to form a closed ring structure. An inflating assembly is provided on the first housing and/or the second housing.

### TECHNICAL FIELD

The present invention relates to the technical field of high-voltage energy extraction devices, and in particular to a CT energy extraction device.

### BACKGROUND

At present, in the high-voltage power system, with the popularization and development in automation technologies such as automatic detection, automatic display, and automatic control of power equipment, the energy supply of equipment in the high-voltage power system becomes the biggest problem. In the existing technology, this problem can be solved mainly by the methods that use high-voltage PT (potential transformer) to obtain energy and CT (current transformer) to obtain energy.

However, the manufacturing process of PT energy extraction devices is complicated, and therefore CT energy extraction devices are widely used more than the PT energy extraction devices. The existing open-type CT energy extraction device has the problem of a large air gap at the core joint surface. In this regard, on the one hand, the existence of the air gap will affect the energy collection efficiency; on the other hand, the magnetic ring joint surface will easily get water due to the air gap, causing rust on the joint surfaces. The rust on the joint surfaces destroys the joint degree of the energy-absorbing magnetic ring, which further affects the energy-absorbing efficiency. In severe cases, it will also cause the magnetic ring to vibrate and heat, thus affecting the life of the CT energy-absorbing device.

### SUMMARY OF INVENTION

Embodiments of the present invention provide a CT energy extraction device to solve the problem in the prior art that there is an air gap in the core joint surface of the CT energy extraction device, which affects the energy extraction efficiency.

In one embodiment of the present invention, the CT energy extraction device includes:

a first housing and a second housing, in which a first accommodation cavity is provided in the first housing, a second accommodation cavity is provided in the second housing, and the first housing can be connected and joined with the second housing to form a ring shape, which is used to be placed on outside of a high-voltage line;

a first iron core disposed in the first accommodation cavity, in which an energy-extraction coil is wound around the first iron core, a cable outlet is provided on the first housing, and the energy-extraction coil has pins extending from the cable outlet;

a second iron core disposed in the second accommodation cavity, in which when the first housing and the second housing are connected and joined, the first iron core and the second iron core are joined to form a closed ring structure;

in which an inflating assembly is provided on the first housing and/or the second housing, the inflating assembly includes an inflating nozzle, an air bag, and a cover. The inflating nozzle is connected to the air bag and is used to inflate the air bag. The cover is used to block the inflating nozzle after inflation is completed; after the air bag is inflated, it can squeeze the first iron core and/or the second iron core, so as to reduce the air gap between joint surfaces of the first iron core and the second iron core.

As a further option solution for the CT energy extraction device, the single air bag is disposed in the second accommodation cavity, and the inflating nozzle is disposed on the second housing.

As a further option solution for the CT energy extraction device, the air bag is arranged between an outer arc surface of the second iron core and an inner surface of the second housing, and the air bag is arranged in a strip shape and along the outer arc surface of the second iron core.

As a further option solution for the CT energy extraction device, an end face of the first iron core for joining with the second iron core is provided with a plurality of protrusions arranged at intervals, and an end face of the second iron core for joining with the first iron core and corresponding to the protrusions is provided with a plurality of grooves, and when the first iron core and the second iron core are joined, the protrusions are inserted into the grooves.

As a further option solution for the CT energy extraction device, an inner wall of the opening of the inflating nozzle is provided with threads, the cover is configured as a screw, and the cover is threadedly connected to the threads of the inflating port.

As a further option solution for the CT energy extraction device, a part of the inflating nozzle used to connect to the cover is made of rubber.

As a further option solution for the CT energy extraction device, the first housing is fixedly connected with a plurality of first connecting lugs, and the second housing is fixedly connected with a plurality of second connecting lugs which are arranged correspondingly to the first connecting lugs. The first connecting lugs and the second connecting lugs are provided with threaded holes, and the threaded holes are used for screwing threaded fasteners.

As a further option solution for the CT energy extraction device, the first housing and the second housing are both configured as cylinders with semicircular end faces.

As a further option solution for the CT energy extraction device, each of the first housing and the second housing includes a top wall, a bottom wall, and a side wall. The bottom wall and the side wall are integrally formed, and the top wall and the side wall are connected by threaded fasteners.

As a further option solution for the CT energy extraction device, an epoxy resin layer is filled between the first housing and the first iron core; and/or an epoxy resin layer is filled between the second housing and the second iron core.

By, implementing embodiments of the present invention, it will have the following beneficial effects:

The CT energy-extraction device uses the first shell and the second shell to encapsulate the first iron core and the second iron core and uses the first iron core and the second iron core to extract energy from the high-voltage line after being joined The CT energy-extraction device is provided with the inflating assembly to promote the first iron core and the second iron core to fit more closely, thereby reducing the air gap between the first iron core and the second iron core and improving energy extraction efficiency. The smaller air gap can also reduce the probability of water entering and rusting the joint surfaces of the first iron core and the second iron core, improving the lifetime of the CT energy-extraction device.

### BRIEF DESCRIPTION OF DRAWINGS

In order to explain embodiments of the present invention or the technical solutions in the prior art more clearly, the drawings as required to be used in the description of embodiments or the prior art will be briefly introduced below. Obviously, the drawings in the following description are only for some embodiments of the present invention. For those of ordinary skill in the art, other drawings can be obtained based on these drawings without exerting creative efforts. There are:

FIG. 1 is a schematic diagram of an internal structure of a CT energy-extraction device according to an embodiment of the present invention;

FIG. 2 is a schematic structural diagram of a first iron core and a second iron core according to an embodiment of the present invention;

FIG. 3 is a schematic structural diagram of a first housing according to an embodiment of the present invention;

description of main component symbols:
10-first housing, 11-first iron core, 111-protrusion, 12-cable outlet, 13-top wall, 14-bottom wall, 15-side wall, 16-first connecting lug;
20-second housing, 21-second iron core, 211-groove;
30-inflating assembly, 31-inflating nozzle, 32-air bag.

### DETAILED DESCRIPTION OF THE INVENTION

In order to facilitate understanding of the present invention, the present invention will be described more fully below with reference to the relevant drawings. Preferred embodiments of the invention are shown in the drawings. However, the present invention may be implemented in many other different forms and is not limited to the embodiments described herein. On the contrary, these embodiments are provided so that a thorough understanding of the disclosure of the present invention will be provided.

It should be noted that when an element is referred to as being “fixed” to another element, it can be directly on the other element or intervening elements may also be present. When an element is recited as to be “connected” to another element, it can be directly connected to the other element or there may also be intervening elements present. The terms “vertical,” “horizontal,” “left,” “right” and similar expressions are used herein for illustrative purposes only.

Unless otherwise defined, all technical and scientific terms used herein have the same meaning as commonly understood by one of ordinary skill in the technical field to which the present invention belongs. The terminology used herein in the description of the present invention is for the purpose of describing specific embodiments only and is not intended to limit the invention. As used herein, the term “and/or” includes any and all combinations of one or more of the associated listed items.

Embodiments of the present invention provide a CT energy extraction device to solve the problem in the prior art that there is an air gap in the core joint surface of the CT energy extraction device, which affects the energy extraction efficiency.

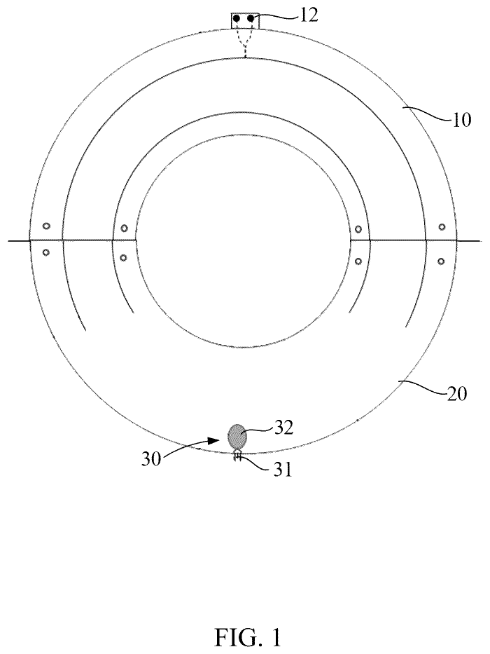

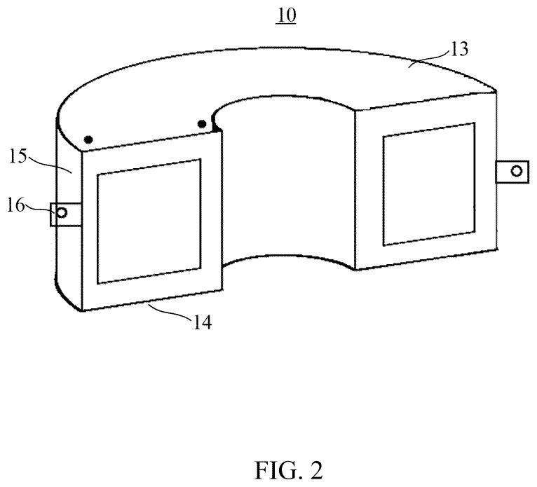

In embodiments of the present invention, combined with reference to FIG. 1 to FIG. 2, a CT energy extraction device includes a first housing 10, a second housing 20, a first iron core 11, a second iron core 21, and an inflating assembly 30. A first accommodation cavity is provided in the first housing 10, a second accommodation cavity is provided in the second housing 20. The first housing 10 can be connected and joined with the second housing 20 to form a ring shape, which is used to be placed on outside of a high-voltage line; the first iron core 11 is disposed in the first accommodation cavity, in which an energy-extraction coil is wound around the first iron core 11. A cable outlet 12 is provided on the first housing 10, and the energy-extraction coil has pins extending from the cable outlet 12; the second iron core 21 is disposed in the second accommodation cavity, in which when the first housing 10 and the second housing 20 are connected and joined, the first iron core 11 and the second iron core 21 are joined to form a closed ring structure; an inflating assembly 30 is provided on the first housing 10 and/or the second housing 20, the inflating assembly 30 includes an inflating nozzle 31, an air bag 32, and a cover. The inflating nozzle 31 is connected to the air bag 32 and is used to inflate the air bag 32. The cover is used to block the inflating nozzle 31 after inflation is completed; after the air bag 32 is inflated, it can squeeze the first iron core 11 and/or the second iron core 21, so as to reduce the air gap between joint surfaces of the first iron core 11 and the second iron core 21.

Generally speaking, the air bag 32 is made of rubber; the cable outlet 12 includes two wire outlets, in which the energy-extraction coil wound on the first iron core 11 extends two wires, and the two wires extend from different wire outlets, so as to connect with the outer wall elements.

The method of using the CT energy extraction device is to fasten the first housing 10 with the first iron core 11 and the second housing 20 with the second iron core 21 to outside of the high-voltage line, and to use an external inflator to inflate the air bag 32 through the inflating nozzle 31. After the air bag 32 is inflated, pressure is exerted on the first iron core 11 and/or the second iron core 21, such that the joint surface parts of the second iron core 21 can fit closer to each other, reducing the air gap between the joint surfaces and improving energy extraction efficiency. It should be noted that, at a condition under good sealing, liquid (such as water) can also be used to replace the gas in the air bag 32, and the use of liquid can also have a certain cooling effect.

The CT energy extraction device uses the first housing 10 and the second housing 20 to encapsulate the first iron core 11 and the second iron core 21, in which the first iron core 11 and the second iron core 21 after being joined are used to extract energy from the high-voltage line, and the inflatable assembly 30 is provided to promote the first iron core 11 and the second iron core 21 to fit more closely, thereby reducing the air gap between the first iron core 11 and the second iron core 21 and improving energy extraction efficiency. The smaller air gap can also reduce the probability of water entering and rusting the joint surfaces of the first iron core 11 and the second iron core 21, improving the lifetime of the CT energy-extraction device.

In one embodiment, the single air bag 32 is disposed in the second accommodation cavity, and the inflating nozzle 31 is disposed on the second housing 20.

In one specific embodiment, the air bag 32 is arranged between an outer arc surface of the second iron core 21 and an inner surface of the second housing 20, and the air bag 32 is arranged in a strip shape and along the outer arc surface of the second iron core 21.

The advantage of using such the embodiment is that after the air bag 32 is inflated, a uniform pressure can be generated on the outer arc surface of the second iron core 21, thereby making the relationship between the first iron core 11 and the second iron core 21 more stable. fit.

In another specific embodiment, a receiving groove is provided on a surrounding wall of the second accommodation cavity, and an airbag 32 is disposed in the receiving groove. When the external inflating device inflates the airbag 32, the air bag 32 bulges out from the receiving groove, thereby promoting the first iron core 11 and the second iron core 21 to engage.

In a more specific embodiment, the second iron core 21 is in the shape of a semicircular arc, and the air bag 32 is located at the midpoint of the outer arc surface of the second iron core 21.

The advantage of employing this embodiment is that thrust can be generated at the midpoint of the second iron core 21, thereby making the first iron core 11 and the second iron core 21 fit together more stably.

It can be understood that in the foregoing embodiments, another air bag 32 can also be provided in the first housing 10, and the air bag 32 in the first housing 10 and the airbag 32 in the second housing are arranged symmetrically. Since the iron core and the energy extraction coil may generate heat to a certain extent during the power extraction process, a heat insulation board or insulation layer can be added between the air bag 32 and the iron core to prevent higher temperatures from adversely affecting the material of the air bag 32.

In one embodiment, referring to FIG. 2, an end face of the first iron core 11 for joining with the second iron core 21 is provided with a plurality of protrusions 111 arranged at intervals, and an end face of the second iron core 21 for joining with the first iron core 21 and corresponding to the protrusions is provided with a plurality of grooves 211; and when the first iron core and the second iron core are to be joined, the protrusions 111 are inserted into the grooves 211, such that the first iron core 11 and the second iron core 21 are joined to each other. Alternatively, the end surface of the first iron core 11 for joining with the second iron core 21 is provided with a plurality of grooves 211, and the end surface of the second iron core 21 for joining with the first iron core 11 and corresponding to the grooves 211 is provided with a plurality of protrusions 111; when the first iron core 11 and the second iron core 21 are to be joined, the protrusions 111 are inserted into the grooves 211, so that the first iron core 11 and the second iron core 21 are joined to each other. It can be understood that the joint surfaces of the first iron core 11 and the second iron core 21 can also be meshed using a zigzag structure or other structures capable of hooking and joining with each other.

The advantage of using this embodiment is that the joint area between the first iron core 11 and the second iron core 21 is larger and the joint is tighter, and it is also convenient to position.

In one embodiment, an inner wall of an opening of the inflating nozzle 31 is provided with threads and the cover is configured as a screw, and the cover is threadedly connected to the threads of the inflating port 31

In one embodiment, the part of the inflating nozzle 31 used to connect the cover is made of rubber.

The advantage of using rubber is that it can increase the air tightness of the connection between the inflating nozzle 31 and the cover and can prevent the air bag 32 from leaking.

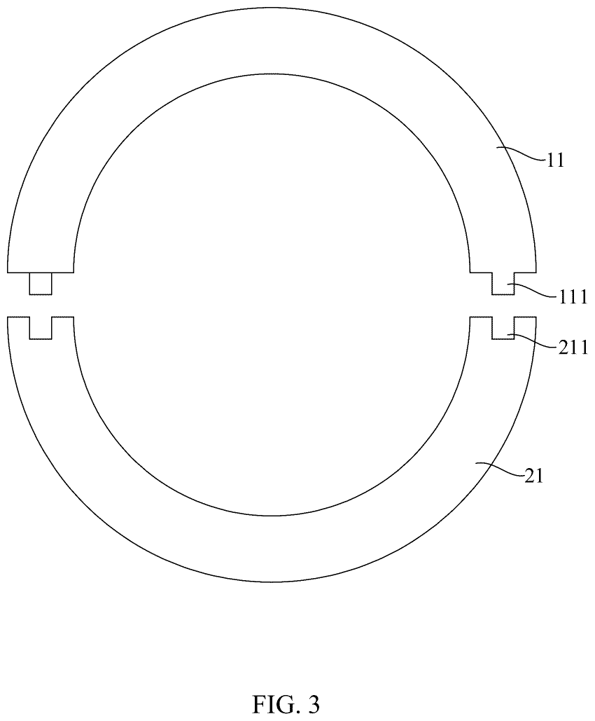

In one embodiment, referring to FIG. 3 (the first housing 10 and the second housing 20 have the same structure, so only the first housing 10 is shown in the drawing), the first housing 10 is fixedly connected with a plurality of first connecting lugs 16, and the second housing 20 is fixedly connected with a plurality of second connecting lugs corresponding to the first connecting lugs 16. The first connecting lugs 16 and the second connecting lugs are provided with threaded holes, and the threaded holes are used for screwing threaded fasteners.

When assembling the first housing 10 and the second housing 20, the first connecting lugs 16 can be fitted to the second connecting lugs with aligning the threaded holes therein and then screwing the threaded fasteners therein. It can be understood that the first housing 10 and the second housing 20 can also be connected by snapping.

In one embodiment, the first housing 10 is hinged to one side of the second housing 20, and another side is connected using a threaded fastener or a snap connection.

In one embodiment, the first housing 10 and the second housing 20 are both configured as cylinders with semicircular end faces.

In one embodiment, each of the first housing 10 and the second housing 20 includes a top wall 13, a bottom wall 14, and a side wall 15. The bottom wall 13 and the side wall 15 are integrally formed, and the top wall 13 and the side wall 15 are connected by threaded fasteners. Specifically, several first connection holes are provided on the upper end surface of the side wall 15, and several second connection holes are provided on the top wall 13 at positions corresponding to the first connection holes. The first connecting hole and the second connecting hole are used for screwing in threaded fasteners.

The advantage of employing this embodiment is that it is easy to install the first iron core 11 and the second iron core 21.

In one embodiment, an epoxy resin layer is filled between the first housing 10 and the first iron core 11; and/or an epoxy resin layer is filled between the second housing 20 and the second iron core 21.

The advantage of providing the epoxy resin layers is that it can provide positioning and buffering effects on the first iron core 11 and/or the second iron core 21.

The technical features of the above embodiments can be combined in any way. To simplify the description, not all possible combinations of the technical features in the above embodiments are described. However, as long as there is no contradiction in the combination of these technical features, all of them should be considered to be within the scope of this manual.

The above-described embodiments only express several implementation ways of the present invention, and their descriptions are relatively specific and detailed, but they should not be construed as limiting the scope of the patent application. It should be noted that, for those of ordinary skill in the art, several modifications and improvements can be made without departing from the concept of the present invention, and these all belong to the protection scope of the present invention. Therefore, the scope of protection of the patent of the present invention should be determined by the appended claims.

What is claimed is:

1. A CT energy extraction device, comprising:
a first housing and a second housing, wherein a first accommodation cavity is provided in the first housing, a second accommodation cavity is provided in the second housing, and the first housing can be connected and joined with the second housing to form a ring shape, which is used to be placed on outside of a high-voltage line;
a first iron core disposed in the first accommodation cavity, wherein an energy- extraction coil is wound around the first iron core, a cable outlet is provided on the first housing, and the energy-extraction coil has pins extending from the cable outlet;
a second iron core disposed in the second accommodation cavity, wherein when the first housing and the second housing are connected and joined, the first iron core and the second iron core are joined to form a closed ring structure;
wherein an inflating assembly is provided on the first housing and/or the second housing, the inflating assembly comprises an inflating nozzle, an air bag, and a cover, the inflating nozzle is connected to the air bag and is used to inflate the air bag, the cover is used to block the inflating nozzle after inflation is completed; wherein after the air bag is inflated, the air bag is able to squeeze the first iron core and/or the second iron core, so as to reduce an air gap between joint surfaces of the first iron core and the second iron core.

2. The CT energy extraction device according to claim 1, wherein the single air bag is disposed in the second accommodation cavity, and the inflating nozzle is disposed on the second housing.

3. The CT energy extraction device according to claim 2, wherein the air bag is arranged between an outer arc surface of the second iron core and an inner surface of the second housing, and the air bag is arranged in a strip shape and along the outer arc surface of the second iron core.

4. The CT energy extraction device according to claim 2, wherein an end face of the first iron core for joining with the second iron core is provided with a plurality of protrusions arranged at intervals, and an end face of the second iron core for joining with the first iron core and corresponding to the protrusions is provided with a plurality of grooves, wherein when the first iron core and the second iron core are joined, the protrusions are inserted into the grooves.

5. The CT energy extraction device according to claim 1, wherein an inner wall of an opening of the inflating nozzle is provided with threads, the cover is configured as a screw, and the cover is threadedly connected to the threads of the inflating port.

6. The CT energy extraction device according to claim 1, wherein a part of the inflating nozzle used to connect to the cover is made of rubber.

7. The CT energy extraction device according to claim 1, wherein the first housing is fixedly connected with a plurality of first connecting lugs, and the second housing is fixedly connected with a plurality of second connecting lugs which are arranged correspondingly to the first connecting lugs, wherein the first connecting lugs and the second connecting lugs are provided with threaded holes, and the threaded holes are used for screwing threaded fasteners.

8. The CT energy extraction device according to claim 1, wherein the first housing and the second housing are both configured as cylinders with semicircular end faces.

9. The CT energy extraction device according to claim 1, wherein each of the first housing and the second housing comprises a top wall, a bottom wall, and a side wall, wherein the bottom wall and the side wall are integrally formed, and the top wall and the side wall are connected by threaded fasteners.

10. The CT energy extraction device according to claim 1, wherein an epoxy resin layer is filled between the first housing and the first iron core; and/or an epoxy resin layer is filled between the second housing and the second iron core.
